(19) United States
(12) Patent Application Publication
(10) Pub. No.: US 2005/0243765 A1
(43) Pub. Date: Nov. 3, 2005

(54) Mesh network and piconet work system and method

(76) Inventors: Mark E. Schrader, Rochester, NY (US); Eric Frayer, New York, NY (US)

Correspondence Address: Thomas R. FitzGerald, Esq.;Suite 210, 16 E. Main St., Rochester, NY, 14614-1803, US

(21) Appl. No.: 11/178,697

(22) Filed: Jul. 11, 2005

Related U.S. Application Data
(63) Continuation-in-part of application No. 10/900,586, filed on Jul. 23, 2004.
(60) Provisional application No. 60/490,388, filed on Jul. 25, 2003.

(51) Int. Cl. H04Q 7/00

(52) U.S. Cl. 370/328

(57) ABSTRACT

A method of distributed control of a wireless mesh network without knowledge of global topology. The method includes: a station joining the network with any current member by propagating the join-request, or two meshes merging using the steps of: one mesh joining the other as a whole and then re-synchronizing its timing. The method further includes: first, each station periodically transmits a beacon; second, in response to a beacon being no longer detected, a station transmitting a bitmap of stations that it can still receive; third, each station responds by adding stations that it can receive with all of the bitmaps received from other members, and retransmitting the updated bitmap; fourth, after time for all stations to respond, all stations base current membership on the bitmap. The method further includes: determining sharable time slots that will not interfere with neighbors or other slot sharers, using and then releasing those slots.

### CROSS-REFERENCE TO RELATED APPLICATIONS

This application claims the benefit of the filing date of U.S. Provisional patent application Ser. No. 60/490,388 filed Jul. 25, 2003 and U.S. Utility patent application Ser. No. 10/900,586. The entire disclosures of both patent applications are hereby incorporated by reference.

### FIELD OF THE INVENTION

This invention is directed to an ad hoc method of controlling and sharing access to a wireless communication mesh of single stations, or smaller wireless communication networks (member stations), wherein the mesh can be created and modified at any time in any location without the need for a central master station.

### BACKGROUND OF THE INVENTION

Wireless communication protocols must handle three distinct situations: First, a network or station joining an established network; second, a station leaving the network; and, third, a station roaming within the network. To accomplish this, there must be a way for stations to communicate their presence to all other stations within range, and communicate changes in what stations they can hear. In prior art time division multiple access (TDMA) protocols, each station is assigned a periodic time slot in which to transmit data. In the prior art related to TDMA protocols, a central master station is required to administer the time slots to the members of the network. In a network where some of the members are out of range of other members, the ability of a central master to communicate with all members of the network may not exist.

Furthermore, in an ad hoc network where member stations are joining and leaving the network at random, there may not be a suitable candidate as the master station. There is a need therefore for an improved protocol for managing access to an ad hoc network that does not require a central master station.

This invention is not concerned with the routing of application data between member stations of the mesh network.

### SUMMARY OF THE INVENTION

The invention provides a method of controlling and sharing access to a wireless mesh network wherein not every station of the mesh network is in range of every other station of the same network. The invention's method includes the steps of: first, each station periodically transmits a beacon (or other forms of control signaling) containing mesh management information, mesh commands, and data to be transferred between member stations; second, in response to a beacon being no longer detected, each station transmits a bit map containing an indication of only the stations whose beacon it can still receive; third, on receiving a bit map with not all stations indicated, each station responds by adding stations that it can receive to the received bit map and transmitting the updated bit map; fourth, each station repeats the third step until the updated bit map indicates that all stations are still in the network or that a member station is missing from the mesh network; and finally, if a station is indicated to be missing from the network, each remaining member station updates the bit map to eliminate the bit position of the missing station. This process is illustrated in FIG. 7. Through the application of these steps, the invention controls access to the network without a global master. This invention's method allows the sharing time slots among member stations that cannot interfere with each other.

The present invention provides a mechanism for two separate mesh networks to be merged into one network. This can happen in two different situations. For the first case, a member from one mesh network directly communicates with the member from the other network, as shown in FIG. 3. The second case is when a station, which is not a member of either mesh network but is within range of at least one member of each mesh network, serves as the common station for communication between the two mesh networks upon joining either of the mesh networks, and then becomes part of the merged network. This invention has the advantage of merging the two mesh networks very efficiently, without needing to reform either network.

The present invention provides a mechanism for two member stations to share the same time slot if the two stations are out of range of each other and have no common neighbors. It allows members of the mesh, who have no global knowledge about the network topology, to discover what other member time slots might be shared without causing interference. It provides a robust and efficient method for managing time slot sharing that is immune to changes in network topology because of stations roaming, new stations joining, or member stations dropping out of the mesh.

In general, the present invention has the advantage of controlling a network without the need for a central master station, and does not require continuous global knowledge of the topology of the network. It provides a mechanism for managing changes in mesh propagation time that is the result of radio interference with transmissions of member stations.

### Glossary of Terms and Abbreviations Used in this Specification

ATS—Acquire Time Slots, mesh command: Used to determine which time slots can be shared without causing interference with other member stations already sharing time slots.
Beacon—Transmission containing information about the member station and the mesh network, and any mesh commands originated or retransmitted by the station.
Beacon Cycle—The sequence of beacons, wherein each member transmits its beacon at the proper time in the sequence. The time between successive beacons is a constant known to each member of the mesh network.
BCC, BCC₁, . . . —Beacon Cycle Count is a variable whose value is an integer number incremented by ‘1’ after each beacon cycle. The value of BCC is modulo the size of the beacon cycle counter. BDBF—Beacon Detect Bitmap/Flag is bitmap in which a ‘1 ’ represents a member station whose beacon some other member station can hear and ‘0’ represents a member station whose beacon cannot be heard by any other member station.
CEC—Change Effect Cycle Count—is the future BCC when the execution of a mesh command will be completed and any changes resulting from that command will take effect.
DMB—Dropped Member Bitmap is equal to the most recent BDBF when BCC=CEC-1 after the execution of an NNC MCmd. The DMB is retained for NS beacon cycles after CEC is reached, that is for BCC=CEC+NS, where NS is the NS computed on the CEC beacon cycle.
EOB—End of Beacon is the field in the beacon that marks that separates the last MCmd from the Join Contention Slot.
GSB—Granted Slot Bitmap is a bitmap of time slots not belonging to a member station that have been granted by the mesh for use by that member station.
JCS—Join Contention Slot is a time slot that a station may use to request to join the mesh. The time slot uses a contention mechanism to resolve collisions between colliding join requests that is beyond the scope of this invention.
LBB—Lost Beacon Bitmap is a bitmap of beacons that have been within range, but are no longer being received. This is mathematically defined as LBB=(NNB₁⊕NNB₀)\hat{ }NNB₀. This is private to each MS and not transmitted to a different MS.
LBL—Lost Beacon List is a variable length field in the NNC MCmd specifying which mesh members that the originator of the NNC MCmd can no longer hear.
MAS—Map Available Time Slots: A mesh command used by a member station to determine the nearest neighbors of its nearest neighbors. The combination of the nearest neighbors and the nearest neighbors of the nearest neighbors represents the set of member stations that are excluded from sharing time slots with the member station originating this command.
MCC—Membership Change Counter: A modulo N counter that is incremented each time a new station joins the mesh or when a member of the mesh is determined to be no longer present.
MCmd—Mesh Command: A command transmitted by a member station in its beacon. An MCmd may be transmitted once or multiple times depending on the MCmd. If it is retransmitted, the parameters sent with the MCmd may change with each retransmission, depending on the MCmd.
MS, MSa, MSx—Member Station is a station that has joined a mesh network and is considered a member by all other members. A Member Station is required to transmit a beacon at its assigned time in the beacon cycle.
Mesh, Mesh Network: A set of intercommunicating of member stations each of which transmit at prescribed times in a predefined manner, and with no source of central control.
MFI—Member Frame Interval: The time between successive beacons in the beacon cycle.
MID—Mesh ID Number: Identifies the mesh network and distinguishes it from other mesh networks. This is a random number created by a station starting the mesh network and in doing so, becoming its first member station.
MPB—MCmd Propagation Bitmap: A bitmap containing one bit per member station of mesh network used to record the progress of propagation of an MCmd throughout the mesh.
NBD—New Beacon Detected, mesh command: Used to indicate that a member station can now receive the beacon from a member station that was previously not heard.
NNB—Nearest Neighbor Bitmap: the position of each bit represents the SID of member of the mesh. A “1” in a bit position means that the corresponding member of the mesh is in range and is audible.
N_{NNB}—Nearest Neighbor Count: The number of members of the mesh that the member station can hear.
NNC—Nearest Neighbor Change, mesh command: A member transmits this when it hears new beacon or when it loses a previously heard beacon. It is used to determine which member stations are still present in the mesh network and which member stations cannot be heard by any other member.
NS, NS1, NS2, etc.—the total number of member stations in a mesh network.
NUSB—Non-Usable Slot Bitmap uses a ‘1’ to represent both a neighbor whose beacons can be heard (nearest neighbor), and the nearest neighbor of a nearest neighbors. The resulting bitmap contains ‘1’s for all the neighbors and all of the neighbor's neighbors.
Piconet—a network in a small physical zone made up of one or more wireless, electronic devices each of which is in range of the controlling station designated as the piconet master.
Piconet Master—A station that is capable of creating and controlling a local piconet. Of all the members of a piconet, only the piconet master can become a member station of a mesh network. RP—Relative Position is the number of lost beacons detected by a member station.
RTS—Release Time Slots, mesh command: Used to communicate to the members of a mesh when one member is no longer using one or more shared time slots.
RUSJ—Request US Join, mesh command: A command sent from a station wanting to join the mesh to a current member of the mesh during the Join Contention Slot portion of the current member beacon.
SAB—Silence All Beacons, mesh command: Used by a joining mesh network to stop beacon transmissions in its own mesh, in preparation for resynchronization with the mesh with which it is merging.
SAM—Synchronize All Members, mesh command: Commands the members of the joining mesh to begin transmitting beacons synchronized with the joined mesh.
Shared Time Slot—The beacon time of a second member station the becomes available to a first member for sharing, when the member stations are spread out enough that the first member is able to use the second member's time slot without interfering with any station. A station may use slots that are confirmed by executing the ATS mesh command.
SID—Member Station ID is the ID that is assigned when an unjoined station joins a mesh network. The SID starts at 1. In this embodiment, each new member station receives the SID equal to 1 plus the total number of members prior to the join. The SIDs of some member stations are revised as a result of member stations dropping out of the mesh network.
SJM—Station Join Mesh, mesh command: Request to join a mesh network as a single station (or as a mesh), used by a member station to inform that remaining member stations an impending join, and the beacon cycle on which the un-joined member shall be treated as a new member.
SMM—Start Mesh Merge, mesh command: Command to both the joining mesh and the joined mesh that the merge process is starting.
SSB—Shared Slot Bitmap: Each member of the mesh uses this private data structure to keep track of what time slots belonging to other members that it is currently using (sharing with them).
TDMA—Time Division Multiple Access is a method by which several wireless stations are able to communicate in one communication channel, without interference, by each being assigned a unique time slot in which to communicate.
US—Unjoined Station is any station that is not a member of a mesh network.

### BRIEF DESCRIPTION OF THE DRAWINGS

FIG. 1 is a diagram illustrating the beacon employed by a member station according to the present invention.

FIG. 2 is a diagram showing the structure of the beacon cycle as recurring sequence of beacons, one for each member of the mesh.

FIG. 3 is a flow chart showing the process of adding a member station to the mesh according to the present invention.

FIG. 4 is the merged mesh beacon sequence as produced by the present invention.

FIG. 5a, FIG. 5b show a dropped member station in a linear mesh network.

FIG. 6a, FIG. 6b, FIG. 6c show a sequence of network diagrams illustrating a dropped member station in a non-linear mesh network as resolved by the present invention.

FIG. 7 is a flow chart showing the process of resolving a lost beacon according to the present invention.

FIG. 8 and FIG. 9 show the overlapping NNC MCmds that can be resolved using the present invention.

FIG. 10a, FIG. 10b, and FIG. 10c, show the network diagrams for a two-member stations lost beacons as resolved using the present invention.

FIG. 11 shows the non-sharable and sharable beacons in a linear mesh network.

FIG. 12 shows the non-sharable and sharable beacons in a non-linear mesh network.

### DETAILED DESCRIPTION OF THE INVENTION

The invention addresses the issue of networking individual stations in an ad hoc mesh wireless network without any mesh network master. The invention establishes a protocol, by which a wireless mesh network can be created at any time in any location, and the membership of the mesh network is managed in an efficient manner. The invention's protocol also provides a way to share network bandwidth without interfering with any members of the mesh network, rendering the invention both more effective and more efficient than conventional methods of creating wireless networks.

The invention's protocol handles three distinct situations regarding the an individual station and its membership in a mesh: (1) an unjoined station (US) joining an established network and thus becoming a mesh member station (MS), or two mesh networks merging into one new mesh network, (2) an MS leaving the mesh network, and (3) an MS roaming within the mesh network. To accomplish each of these changes, the MSs communicate their presence to all stations within range, and communicate changes in what stations they can hear. A small time slot has been set-aside for this purpose at the beginning of each MS assigned time slot. An MS uses this small slot of time to transmit the beacon.

The Beacon

The beacon is an important part of each time slot. The information transmitted by MS in its beacon allows an individual MS to determine local area knowledge, and network changes based on this knowledge. The information carried by each MS beacon includes:
Mesh ID (MID)
Member Station ID (SID, a number assigned to each US when it joins the network and becomes an MS. The MS numbering is sequential and based on the total number of MSs in the mesh. For this document, the value of each new member station will be 1 plus the total number of stations in the network. Other embodiments are possible.)
Total Number of Mesh Member Stations (NS, the total number of MSs in the network)
Beacon Cycle Count (BCC, the number of cycles that have passed since the network was established, modulo the size of the counter.)
Membership Change Counter (MCC, a number that is incremented each time a new station joins the mesh, or when a member of the mesh is determined to be no longer present, modulo the size of the counter.)
Mesh Command (MCmd, is a command used for network management.) Examples of MCmds a command to inform the network that a US is joining as of a specific BCC in the future, that a current MS is no longer heard by another MS, or to share a time slots with MSs that are well out range of the MS owner of the slot. The MCmd field is variable in length depending on the number of current commands circulating in the mesh. This is also an area where parameters specific other embodiments would be added, such as routing information, CRC, FEC, etc.
End of Beacon (EOB, indicates that the last MCmd has occurred and what follows is the contention slot for join request.)

Table 1 summarizes the above list. The BCC is determined and incremented by the root station. The root station is the MS with the lowest SID number in the mesh network. Each joining MS is assigned an SID that is larger than the SID of the most recently joined member. Thus, the SID number always distinguishes the order in which member joined in relative to all other MSs. An SID number can change when an MS leaves the network, or when a new station joins.

TABLE 1
Beacon Fields

| Name | Description |
|---|---|
| Mesh ID (MID) | A random number assigned by the first member of the mesh to |
| | help distinguish this mesh network from other mesh networks. |
| Member Station ID (SID) | The ID for an MS that is determined by the total number of |
| | members in the mesh network at the time that the join occurs. |
| Total Number of Member | The current number of member stations in the mesh network. |
| Stations (NS) | |
| Beacon Cycle Count | A number incremented once at the beginning of each beacon |
| (BCC) | cycle (modulo the width of the counter) by the MS with the |
| | smallest SID. |
| Membership Change | A counter that incremented each time a new station joins |
| Counter (MCC) | the mesh or when a member of the mesh is determined to |
| | be no longer present. MCC indicates a change in mesh |
| | membership. |
| Mesh Commands: | The MCmd field may be absent if there are currently no |
| MCmd₁ | MCmds, or up to N MCmds. The size of N depends on the type |
| . . . | of MCmds present, since the MCmds can be different lengths. |
| MCmd_{N} | The maximum size of the MCmd field is a mesh-wide constant. |
| End of Beacon Flag | Indicates that the Join Contention Slot will begin immediately |
| (EOB) | after this field. (The values available for MCmds shall not |
| | include the value used for EOB.) |

The Member Frame (MF) and the Join Contention Slot (JCS)

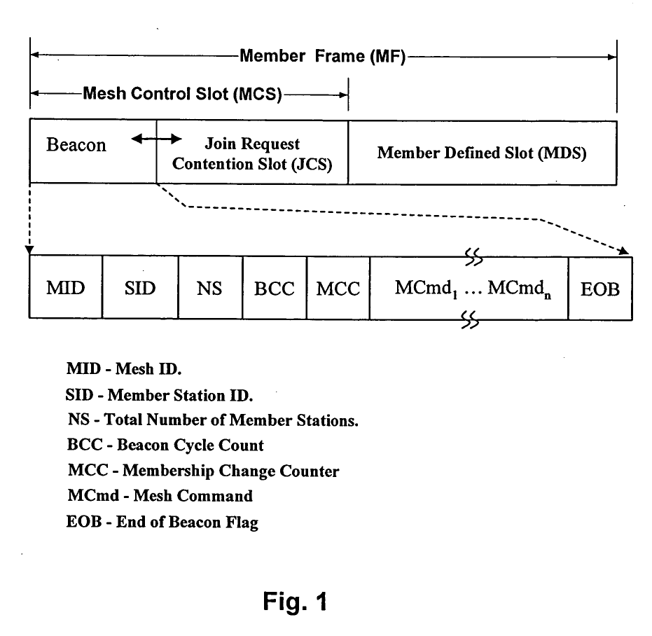

The MF is the entire slot of time owned by an MS. It consists of the Mesh Control Slot (MCS) and the Member Defined Slot (MDS). These structures are also shown in FIG. 1. The MCS consists of the Beacon, as defined previously, and the Join Contention Slot (JCS). The JCS allows a US within range of an MS to send a request-to-join command to the MS in this slot. The MF may use Slotted Aloha, CSMA/CA, or other methods to start contention-based access. This invention does not depend on the embodiment of the JCS functionality.

The Beacon Cycle

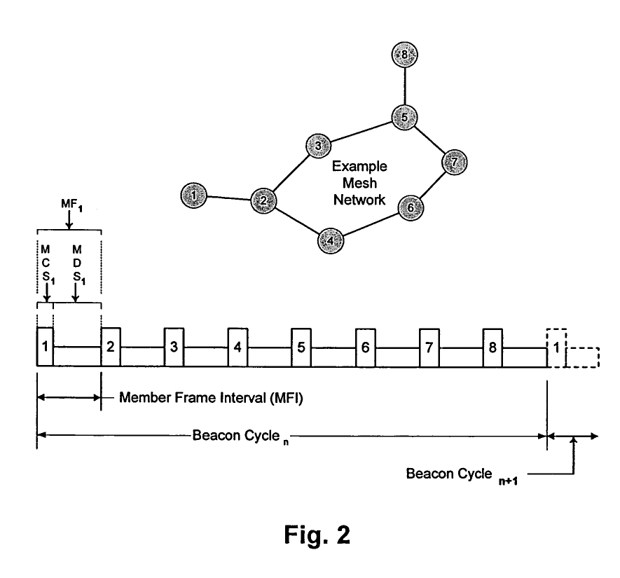

FIG. 2 shows the beacon cycle. The beacon cycle consists of a sequence of the beacons from all MSs. The time between each successive MS beacon is a constant called the member frame interval (MFI). A beacon cycle begins with the beacon from the MS with the lowest SID (i.e., the root MS), followed by each successive SID, in a numerical order. After the last MS (i.e., which has the highest SID) sends its beacon, the sequence repeats from the lowest number SID.

The member frame interval is a constant known to all members of the mesh. The BCC is incremented at the beginning of each beacon cycle and remains constant throughout the remainder of it. Each MS keeps track of the period of the beacon cycle and the BCC so that it can independently transmit the correct BCC for each cycle. Typically, the root MS sends the updated BCC and the other MSs just repeat its value unless the root MS roams out of range or powers down.

Mesh Command Operation Principles

A MCmd is transmitted in the beacon after the BCC. Although various types of MCmds are possible, all require the same mechanism for execution. The MCmd requires that one MS, the originator, sends the initial MCmd in its beacon. Then each recipient MS receives the MCmd, performs an operation if required by the MCmd, and then retransmits the MCmd in its own beacon if required by MCmd. The recipient typically alters one of the received parameters in the MCmd before retransmitting it. This process continues for the prescribed period of time indicated by a field in the MCmd itself. This may result in an MS receiving and retransmitting the MCmd more than once. Whether this happens depends on the command and the network topology.

All MCmds have at least one common parameter transmitted with them. The parameter common to all of the MCmds is the Change Effect Cycle Count (CEC). The CEC is a future value of the BCC when each and every MS in the mesh has performed the operation defined by the MCmd and the execution of the MCmd is completed. The originator computes the CEC by adding a value called delta-T, or ΔT (in units of beacon cycle counts), to the current cycle count, BCC. AT represents a time delay estimate, based on cycles of beacon transmission, needed to propagate the command and perform required tasks before the action takes effect. The value of ΔT varies depending on the number and topology of the MSs in the network, as well as the type of action taking place. (The calculation of ΔT values will be specified for each MCmd that is subsequently described). Some MCmds must reach each member in the mesh only once. These requires less time to propagate than MCmds that are received and then retransmitted with changed parameter fields, since the retransmissions must also propagate to all members of the mesh. In some cases multiple MSs will start propagating the same MCmd, but with different CECs. In the case of multiple instances of the same MCmd received by an MS during a single beacon cycle, the MS shall resend the only one copy of the MCmd, and use the smallest CEC value received.

The basic form of an MCmd is shown in Table 2. The Length of MCmd field is used to allow for: (1) The fact that the size of a bit map parameter will increase by one bit for each MS in the network, (2) Commands that are not interpretable by all MSs in the mesh, and (3) Commands with a variable number of parameters. In the second case, an MS can skip the command, and in the third case, an MS can add or remove a parameter during the execution process.

TABLE 2
MCmd Format
General MCmd Format

| Parameter | Data Type | Value or Note |
|---|---|---|
| MCmd Code | U8 | Assumes a maximum of 254 MCmds |
| Length of | U8 | Minimum = Size of BCC |
| MCmd | | |
| Originator SID | Size of SID | SID of the MCmd originator. |
| CEC | Size of BCC | Range of BCC |
| Param1 | MCmd dependent | Some MCmds have no Params. |
| . | . | . |
| . | . | . |
| . | . | . |
| ParamN | MCmd dependent | Some MCmds have no Params |

Nearest Neighbor Bitmap

Each MS generates and maintains an internal bit map of all neighboring MSs whose beacons can be properly received. This bitmap is called the nearest neighbor bitmap, NNB. The size of the NNB (in bits) is equal to value of NS, and the bit order corresponds to the SID number. One bit in the bitmap is reserved for each MS in a mesh network. The least significant bit, lsb, which in this embodiment is on the right hand end of the string, refers to the root MS (SID=1) and the most significant bit, msb, refers to the most recent MS to join the mesh (SID=NS) and is on the left hand end of the string.

An example of a bitmap for an MS, when NS=9, that can receive beacons from MS₄, SID=4, MS₅, and MS₈ is 010011000.

The algorithm for updating the NNB is not part of this invention, but it is assumed that the loss of a previously received beacon shall persist long enough to be correctly interpreted as the MS no longer transmitting or no longer within range.

### OPERATION OF THE INVENTION

The process of managing a mesh network must consider all possible scenarios: a single station joining the mesh, combining together two mesh networks, removing a member from the mesh network, and movement of a member within the mesh network. Each scenario is different but this invention allows all scenarios to be treated in similar and consistent ways. In most of this section, the mesh network will be assumed to be operating in an interference-free environment. Operation in the presence of interference is considered at the end of this section.

Unjoined Station Joining a Mesh Network

First, the US shall be in range of one or more MSs in order to join the mesh. The US shall select an MS within range, MSₖ. Then the US shall send a Request-US-Join command (RUSJ) in the JCS (after the EOB field in the beacon). The RUSJ command is shown in Table 4. MSₖ shall immediately acknowledge the RUSJ command in the JCS. The MS that received the RUSJ shall then authenticate the US to determine if it is permitted to join the mesh. (The authentication process is beyond the scope of this invention.) If authentication is successful, MSₖ shall then transmit the Station Join Mesh (SJM) MCmd in its next beacon. The CEC field in the SJM MCmd informs the US and all the MSs in the mesh network when the US will become a member of the mesh. The CEC defines the beacon cycle on which the US will officially become an MS and begin transmitting its own beacon.

TABLE 4
RUSJ, Contention Slot Command Format
Request US Join (RUSJ)

| Parameter | Data Type | Value or Note |
|---|---|---|
| MCmd Code | U8 | RUSJ Value |
| Length of MCmd | U8 | Size of SID + Size of NS |
| Originator SID | Size of SID | SID of the RUSJ originator. |
| Number US to Join | U8 | 1 for a US join |

Station Join Mesh (SJM) MCmd

This SJM command shown in Table 5 is transmitted (originated) by the join MS, to inform all MSs that a new member will bejoining on the beacon cycle specified by the parameter CEC=BCC+ΔT. Where BCC is always the current beacon cycle and ΔT depends on the amount of knowledge that join MS has about the propagation time of its messages. The worst-case number for ΔT in beacon cycles is SID. This worst case occurs for a linear mesh in which, MS₁ is in range of MS₂, MSₖ is in range of MSₖ₋₁ and MSₖ₊₁, for k=2,3,4 . . . (NS−1), and MS_{NS} is in range of MS_{NS-1}. Since the exact topology of the network cannot be known because an MS only knows what MSs are within range, the SID value shall be used for ΔT.

If the number of beacon cycles required for a command to propagate from the join MS to the root MS is T_{PR} and is known to the join MS, then ΔT is the T_{PR}+2. This is true because once the MCmd reaches the root, it will propagate to all MSs on the next, ΔT=T_{PR}+1, beacon cycle. Thus the join can always happen on the ΔT=T_{PR}+2 beacon cycle.

TABLE 5
SJM MCmd Format
Station Join Mesh (SJM)

| Parameter | Data Type | Value or Note |
|---|---|---|
| MCmd Code | U8 | SJM Value |
| Length of MCmd | U8 | Size of SID + Size of NS + Size of |
| | | BCC |
| Originator SID | U8 | SID of the SJM originator |
| CEC | Size of BCC | BCC + ΔT (=SID if 1 MS join) |
| Number US to Join | U8 | =1 for a single US, and >1 for a mesh |
| | | join/merge |

Starting with the root MS, the CEC beacon cycle includes the new MS. The MCC and the NS are both incremented by one before being broadcast in the beacon, and the beacon cycle is extended by one member frame interval (MFI) during which the new MS transmits its first beacon.
Combining Two Mesh Networks Into One Mesh Network

The previous case showed a single US joining an existing mesh. The general case is if any MS from an existing mesh network comes within range of an MS from another mesh network, or if a single US comes within range of two separate mesh networks. In either case, the two networks must join/merge into one mesh network. The following is the sequence of actions that occur in adding Network 2 to Network 1, when a member of Network 1 comes within range with a member of Network 2.

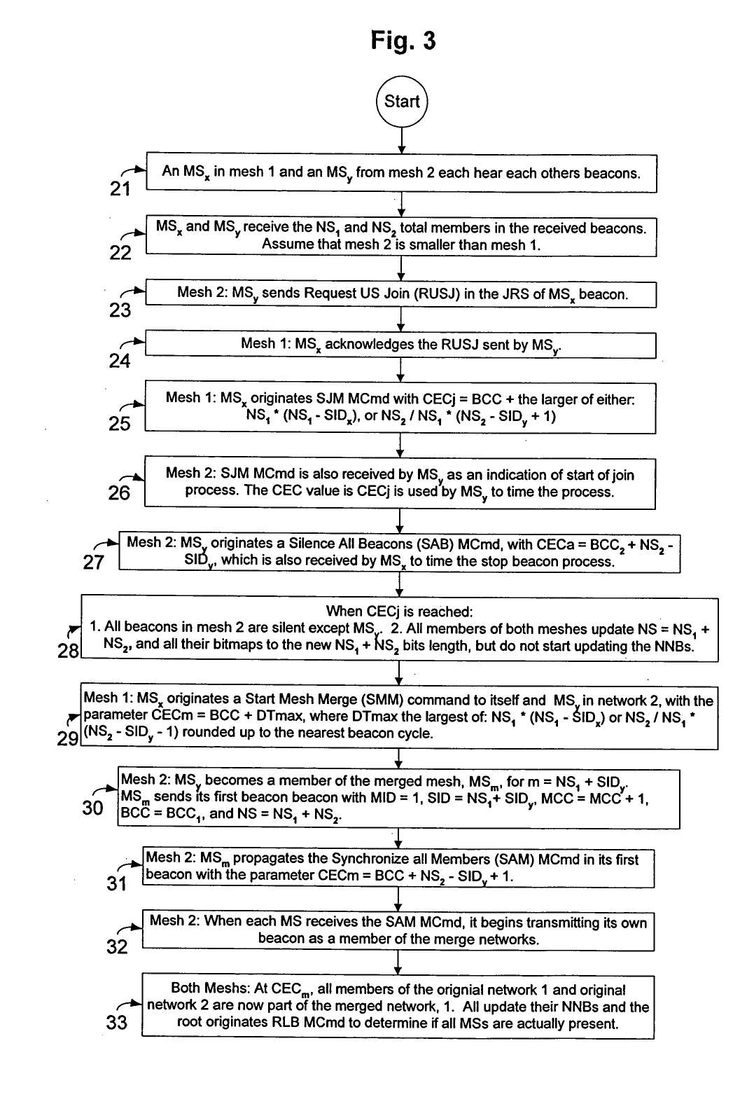

Refer to FIG. 3. At the Step 21, two MSs from different mesh networks detect each other. The two mesh networks, 1, and 2, discover overall network sizes (NS1, NS2) and respective SIDs (SIDₓ and SID_{y}) at Step 22 by receiving the beacon from corresponding members, MSₓ and MS_{y}.

In Step 23 the MSy of the smaller mesh network, 2, submits Request US Join, RUSJ, command in the JCS that occurs at the end of the MSₓ beacon. MS_{y} transmits NS₂ as the Number-of-US-to-Join parameter to signal that a mesh is joining instead of a single US. MSₓ immediately acknowledges receipt of the RUSJ command in Step 24.

In Step 25, Network 1 initiates the join. MSx originates the SJM MCmd with the Number of US to Join field set to the overall size of mesh Network 2, NS₂. The CEC parameter (CECj) is set to BCC₁+ΔTmax, where BCC₁ is the current value of BCC for Network 1, and ΔTmax is the largest of the two quantities: NS1*(NS₁−SIDₓ), or NS₂/NS₁*(NS₂−SID_{y}+1). This is required because while Network 1 is propagating the SJM message, Network 2 will propagate a command originated by MS_{y} to silence all of its beacons except that of MSy. The longest prorogation time is used to time the total join process. The entire membership of Mesh 2 will join Mesh 1 on the same CECj. The newly joined group will not, however, be able to participate in the mesh until they are resynchronized with the original members of Mesh 1.

In Step 26, MS_{y} in Network 2 also receives the SJM MCmd originated by MSx in Step 25. MS_{y} times the join process in terms of its own beacon cycles as ΔT=(CECj−BCC₁)*(NS₁/NS₂)+BCC₂.

In Step 27, MS_{y} originates a Silence All Beacons (SAB) MCmd (see Table 6) with the CEC parameter set to CECa=BCC₂+ΔT=BCC₂+NS₂−SID_{y}, whereas MSx also receives this MCmd and uses the ΔT=(CECa−BCC₂)*(NS₂/NS₁)+BCC₁+1, rounded up the next BCC, to time the SAB execution. Except for MS_{y}, each MS in mesh Network 2 stops transmitting its beacon temporarily to eliminate interference and as the first step in resynchronization of Network 2 to the timing of mesh Network 1.

TABLE 6
SAB MCmd Format
Silence All Beacons (SAB))

| Parameter | Data Type | Value or Note |
|---|---|---|
| MCmd Code | U8 | SAB Value |
| Length of MCmd | U8 | Size of SID + Size of BCC |
| Originator SID | U8 | SID of the SAB originator |
| CEC | Size of BCC | BCC + (SID of MSy) |

In Step 28, the CECj time is reached and the join portion of the join/merge is complete. Any station that is transmitting beacons from this point is now a member of the combined mesh network. (Initially, MS_{y} will be the only member of mesh Network 2 to transmit a beacon in the combined network.) All members of both mesh networks update NS, to NS₁+NS₂, and adjust the size of bit maps and the beacon cycle timing to be consistent with the NS change. The MSs of Network 1 do not start updating their NNBs at this time, but wait until the merge is complete.

In Step 29, MSx originates the Start Mesh Merge (SMM) as an MCmd to its own mesh and as a command to MS_{y}. This MCmd is propagated with the parameter NSₘ=NS₁+NS₂, CECₘ=BCC+NSₘ*DTmax, where DTmax is the largest of: (NSₘ−SIDₓ+1) and (NSₘ−SID_{y}+2). This tells mesh Network 1 to prepare for the merge and for MSy to start the merge of Network 2. Table 7 shows the SMM command format.

TABLE 7
SMM MCmd Format
Start Mesh Merge (SMM))

| Parameter | Data Type | Value or Note |
|---|---|---|
| MCmd Code | U8 | SMM code |
| Length of | U8 | Size of SID + Size of BCC + Size of NS |
| MCmd | | |
| Originator SID | U8 | SID of the SMM originator |
| CEC | Size of BCC | BCC + (SID of MSy) |
| NSm | Size of NS | Sum of NS1 and NS2 |

In Step 30, MS_{y} hears the MSₓ beacon with BCC=CECm, and changes its identity from being a member of mesh Network 2, to the identity of being a member of the merged mesh network. To designate this new identity, the name of MS_{y} will be changed to MSₘ for the remainder of this section.

In Step 31, Starting from this current BCC, which is the BCC of the original network 1, MSm sends a beacon at the proper time for a member of the merged mesh with the following beacon parameters: MIDₘ=1, SIDₘ=NS₁+SID_{y}, NSₘ=NS₁+NS₂, and MCC=MCC+1. MSₘ also sends the MCmd Synchronize All Members (SAM) with CECm=NSₘ−SIDₘ=NS2−SIDy, which is received by its original Mesh 2 neighbors, who are waiting for this transmission. The SAM MCmd is shown in Table 8. The MSs of mesh Network 2 use the Size-of-Joined-Mesh parameter (NS,) to calculate their new SIDs and the size of the merged mesh.

TABLE 8
SAM MCmd Format
Synchronize All Members (SAM)

| Parameter | Data Type | Value or Note |
|---|---|---|
| MCmd Code | U8 | SAM code |
| Length of MCmd | U8 | Size of SID + Size of BCC |
| Originator SID | U8 | SIDy of the SAM originator |
| CEC | Size of BCC | BCC + (SID of MSₘ) |
| Size of Joined Mesh | Size of NS₁ | Size of mesh being joined |

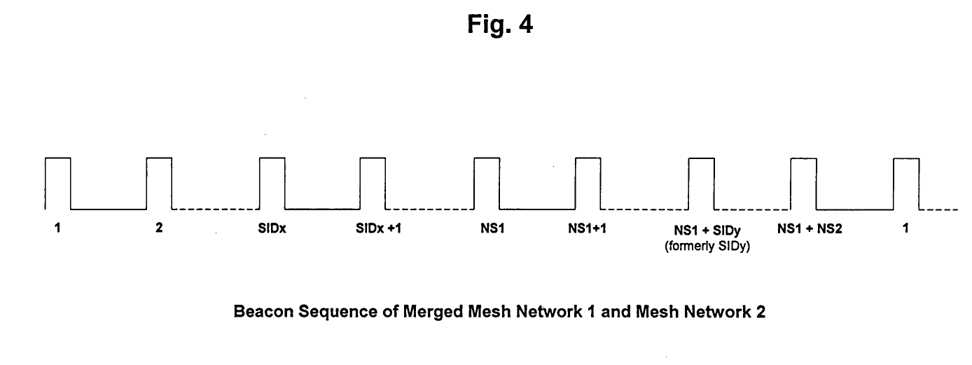

In Step 32, each neighbor of MSₘ sends its own beacon as a new member of the merged network. The new SID of each MS becomes its old SID added to NS₁. This process continues until the CECm beacon cycle, as neighbors of neighbor hear the SAM MCmd and then propagate the command on to their own neighbors as members of the merged network. Thus, the (smaller) network 2 gets new ID numbers that are calculated by adding their current ID number to the size of the larger network. The smaller network also adopts the larger network's beacon cycle count. The merged network size becomes the sum of the sizes of the two networks and all bitmaps are expanded accordingly. FIG. 4 shows the sequence of beacons for the merged mesh network.

The final action in Step 32 is for MS₁ (SID=1) of the merged mesh network to originate a Nearest Neighbor Change MCmd. The function performed by this MCmd is to determine if the beacon of every MS of the merged mesh can be heard by at least one other MS, which confirms that all merged MSs are actually present. The definition and operation of this MCmd will be described in the next section.

Resolving Mesh Membership After the Loss of a Beacon

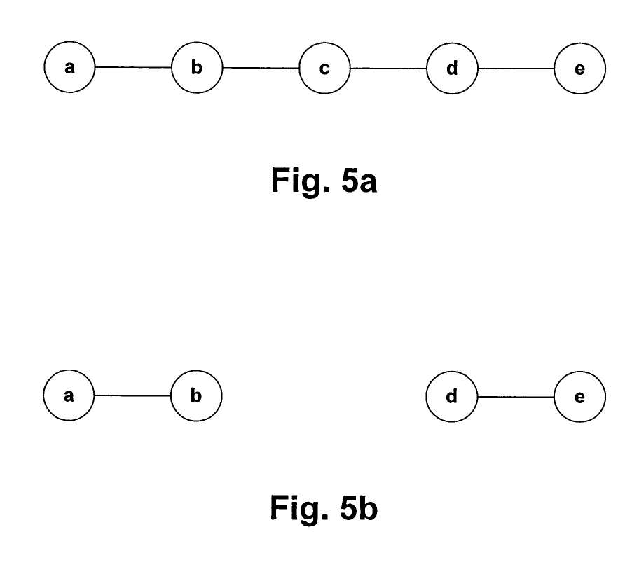

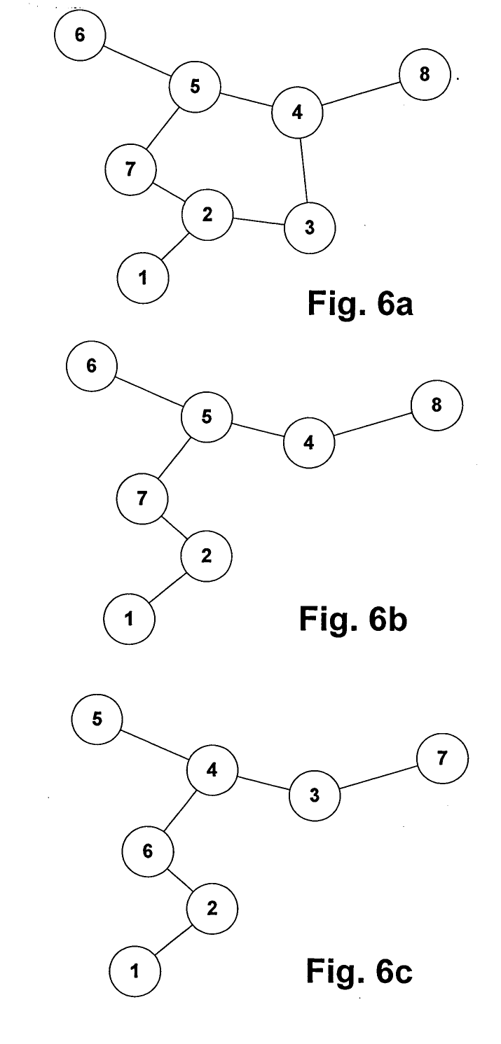

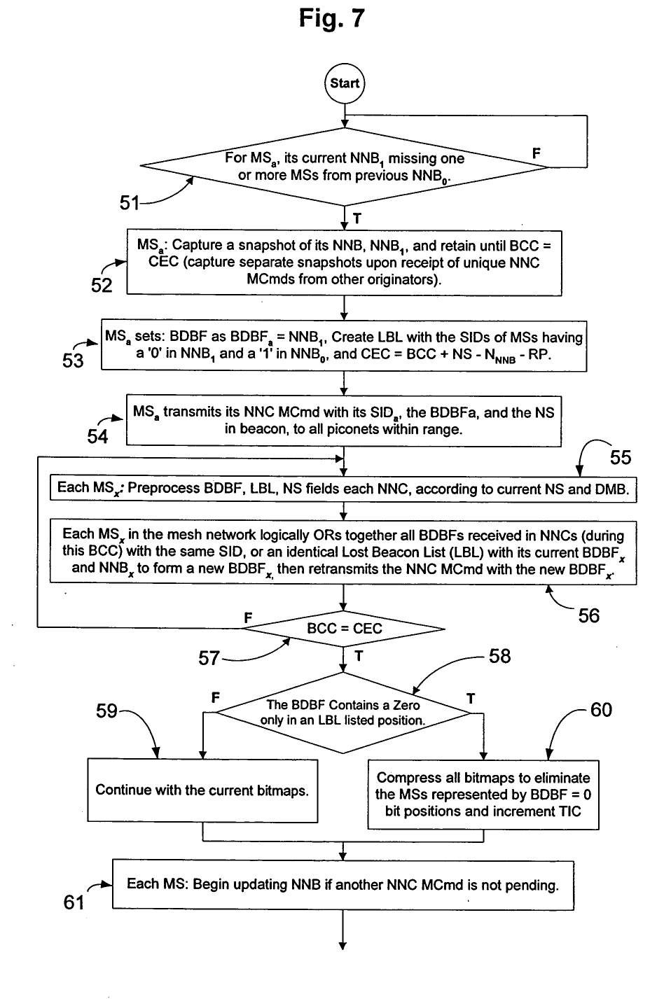

An MS may move outside the range of the mesh network or simply cease transmitting its beacon. This would mean that the MS is no longer a part of the mesh and should not have a reserved time slot for its member frame. The lack of a beacon may change the network topology in several ways. FIG. 5a and FIG. 5b show a linear mesh network in which an MS leaves the network. FIG. 6a and FIG. 6b show a nonlinear mesh network in which an MS leaves the network. FIG. 6c shows the network re-organizes itself after the detection of the departing MS. FIG. 7 shows a flowchart of the process whereby a departing MS is detected and dropped, and network operation continues.

In Step 51 of FIG. 7, by comparing its current Nearest Neighbor Bitmap (NNB₁) to the image of its previous NNB (NNB₀), MSₐ has detected that it can no longer receive the beacons of one or more members (‘0’s in NNB₁), which were previously represented as ‘1’s in NNB₀ of MSₐ.

In Step 52, the detecting MSₐ takes a snapshot of its NNB at its current value, NNB₁, which is saved until CEC is reached.

In Step 53, the detecting MSₐ prepares to send an MCmd by calculating several parameters. First, MSₐ creates a list of the beacons that have been lost, the Lost Beacon List, LBL. The members of the LBL {MSᵢ} are the MSs represented by ones in the result of (NNB₁⊕NNB₀)\hat{ }NNB₀, where ⊕ is the exclusive OR operator and \hat{ } is the logical AND operator. For convenience, the result of this expression shall be referred to as the Lost Beacon List, LBL=(NNB₁⊕NNB₀)\hat{ }NNB₀.

In addition, MSₐ begins keeping a running value of the Beacon Detect Bitmap Flag, BDBFₐ, which it initializes to NNB₁. The further use of BDBF is outlined in subsequent steps.

Finally, MSₐ calculates the parameter CEC=BCC+ΔT, where ΔT=NS−N_{NNB1}−RP. N_{NNB1} is the number of neighbors still within range (i.e., number of ‘1’s remaining in NNB₁). RP is the relative position of ‘1’s in the LBB with respect to MSₐ. RP is equal to the number of ‘1’s in the LBB that represent MSs with a larger SID than MSₐ. For example, if SIDₐ=5 and LBB=0101000010, then the value of RP is 2 since the ‘1’s in LBB are located at SIDs 2, 7, and 9. If LBB=0000001011, then RP=0, because all SIDs represented by the ‘1’s are in lower bit positions than SIDₐ=5.

In Step 54, MSₐ shall send the Nearest Neighbor Change, NNC command, which is shown in Table 9, with its SIDₐ as the Originator SID, the CEC and BDBF calculated in Step 52, and an LBL consisting of the ‘1’ bit positions (SIDs) in the LBB.

Step 55 is discussed in the section titled “Conditional Preprocessing of NNC Fields.” For this discussion, assume that no preprocessing of a received NNC MCmd is required.

TABLE 9
NNC MCmd Format
Nearest Neighbor Change (NNC)

| Parameter | Data Type | Value or Note |
|---|---|---|
| MCmd Code | U8 | NNC Value |
| Length of MCmd | U8 | Size of CEC + ┌NS/8┐ Bytes + 2 * (Size |
| | | of NS) + (n + 1) * (Size of SID) |
| CEC | Size of BCC | BCC + NS − N_{NNB} − RP |
| Originator SID | Size of SID | SID of the NNC originator. |
| Origination NS | Size of NS | NS at Origination BCC. Used to resolve |
| | | overlapping NNC MCmds |
| Beacon Detect Bitmap Flag (BDBF) | ┌NS/8┐ Bytes | Originator initializes to NNB |
| Lost Beacon List (LBL) Length | Size of NS | The value, n, is always greater than or |
| | | equal to 1 and less than NS |
| Lost Beacon List (LBL) SID(1) | Size of SID | Smallest lost beacon SID |
| . | . | . |
| . | . | . |
| . | . | . |
| Lost Beacon List (LBL) SID(n) | Size of SID | Largest lost beacon SID. |

Step 56 applies to all members of the mesh network including MSₐ. It is assumed that the NS parameter in any received NNC command is equal to the NS in the beacon. If this is true, the NNC command is executed throughout the mesh as follows:

When any MSₓ receives more than one NNC MCmd during one beacon cycle, they are reduced to a set of unique NNCs using the following rules:
1. Any NNCs with identical LBLs shall be combined into one NNC and retransmitted. This is true regardless of whether they have the same or different Originator SIDs.
2. Each retransmitted NNC is defined as a unique NNC.
3. The CEC shall be the smallest CEC received, and the Originator SID shall be that contained in the NNC with the smallest CEC.
4. The NS is the current beacon NS, which for this case is also common to all NNCs MCmds.
5. Before a unique NNC MCmd, NNCₖ, is retransmitted, the receiving MS, MSy, recomputes the BDBF parameter. The received BDBF parameter shall be called BDBFr and the recomputed-for-transmission BDBF parameter shall be called BDBFt. BDBFt is the logical OR of all of the following:
   All of the BDBFr values associated with each unique NNCₖ that have been received since the previous beacon was transmitted:
   The BDBF retransmitted in the previous beacon by MSₓ, NNC associated with the same unique NNCₖ.
   For the receiver of the NNC MCmd, MSₓ: the current (sampled) value of the NNB, NNB₁, with a ‘1’ added back into any bit position that is not in the received LBL, and is in the LBL of a pending NNC MCmd that was originated by MSₓ.

The receiving MSₓ retransmits all of the unique NNC MCmds with the new BDBFs, the current NS, and the originator SID associated with the smallest CEC, for each common LBL.

To summarize the previous receive logic for a unique NNC1: When any MS receives an NNC command and if this is the first time that the NNC MCmd has been received, then MSₓ takes a snapshot of its current NNB, NNB₁, but preserves the ‘1’ for any distinct lost beacon that had resulted in the MS sending its own pending NNC MCmd.

Regardless of whether or not this is the first time that the NNC MCmd has been received, MSₓ ORs its NNB₁ with every received BDBFr for that NNC and LBL combination. The result is that the retransmitted BDBFt is a result of BDBFr₁ [symbol] . . . [symbol] BDBFrₙ [symbol] NNB₁.

One final rule is that while an MS is executing one or more NNC MCmds, it shall not originate its own NNC command until the CEC+1 beacon cycle of the last NNC pending. At that time, the MS may take a snapshot of its NNB and compare the snapshot with its NNB (adjusted for dropped MSs) at the point when the first NNC was received.

Step 57 shows that this process shall be repeated until the CEC for the unique NNC MCmd is reached.

When the CEC beacon cycle is reached, the meaning of a “1” in BDBF bit position k (where k is one of the SIDs listed in the LBL) is that “at least one MS in this mesh network can receive the beacon that is transmitted by MSₖ”. The meaning of a zero in bit position j is “No MS in this mesh network can receive the beacon that was transmitted by MSⱼ.” Thus, zero specifies that the station is no longer part of the mesh. Every MS in the mesh network has the same BDBF on the CEC-1 beacon cycle unless there is a ‘0’ in a bit position not listed in the LBL, in which case the NNC MCmd has not propagated through the entire mesh and must be propagated for additional beacon cycles. The exact number of additional beacon cycles is outside the scope of this invention.

Step 58 and Step 60 show that if the BDBF contains a ‘0’ in a bit position specified by an LBL entry and nowhere else, then the MS takes the following actions on the CEC beacon cycle:
1. The MCC is incremented by one to indicate that a new iteration of the mesh membership is in effect.
2. The existence of ‘0’s in the BDBF compresses all bitmaps. The corresponding MSs are thus dropped from the network. The value of NS is also decremented by the number of ‘0’s.
3. If a remaining MS has a larger SID than the SID associated with the bit position of one ‘0’ in the BDBF, then it shall decrement its SID by 1 before transmitting its beacon. If an MS has a larger SID than the bit position of two ‘0’s, in the BDBF, then the MS shall decrement its SID by 2, and so on. This results in all MSs having consecutive numbers with no gaps in the sequence. The SIDs remain a function of the bit map bit position, although for some embodiments they may not be equal to that index.
4. Any bitmap that is the old NS in length shall be shortened to the new NS length by removing bits corresponding to the ‘0’s in the BDBF.
5. The MS shall keep a temporary bit map called the Dropped Member Bitmap, DMB. The DMB is equal to the BDBF when BCC=CEC−1, and it shall be retained for NS additional beacon cycles after BCC=CEC. The use of this is described in the next section.

In Steps 58 and 59, if the BDBF is all ‘1’s, then the all MSs are still members of the mesh and no changes to bitmaps are required. This can occur if an MS changes its transmit power, or roams out of range of one MS and is in range of another MS.

Table 10 summarizes the variables that an MS shall keep for each unique NNC MCmd originated or received. All variables, except for DMB, are no longer needed at CEC time. DMB is no longer needed on the CEC+NS beacon cycle.

TABLE 10
Temporary MS Variables Per Unique NNC MCmd

| Variable | Description |
|---|---|
| Originator SID | The originator's SID received in the NNC MCmd |
| | Originator SID field. |
| Origination NS | When the originator transmits the NNG command, it |
| | replicates the value of the beacon NS in the Originator |
| | NS field. |
| LBL | The variable length Lost Beacon List field in the NNC |
| | MCmd lists the beacons no longer heard by the NNC |
| | originator. |
| CEC | The CEC field received in the NNC MCmd specifies |
| | the BCC when execution of the NNC MCmd will be |
| | completed. |
| NNBi | The MS sample of its Nearest Neighbor Bitmap taken |
| | when the NNC was first received or originated. |
| BDBFt | The value of BDBF in the previously retransmitted NNC |
| | MCmd |
| DMB | The Dropped Member Bitmap is a record of the final |
| | BDBF at time BCC = CEC − 1. |

Step 55: Conditional Preprocessing of Received NNC Fields

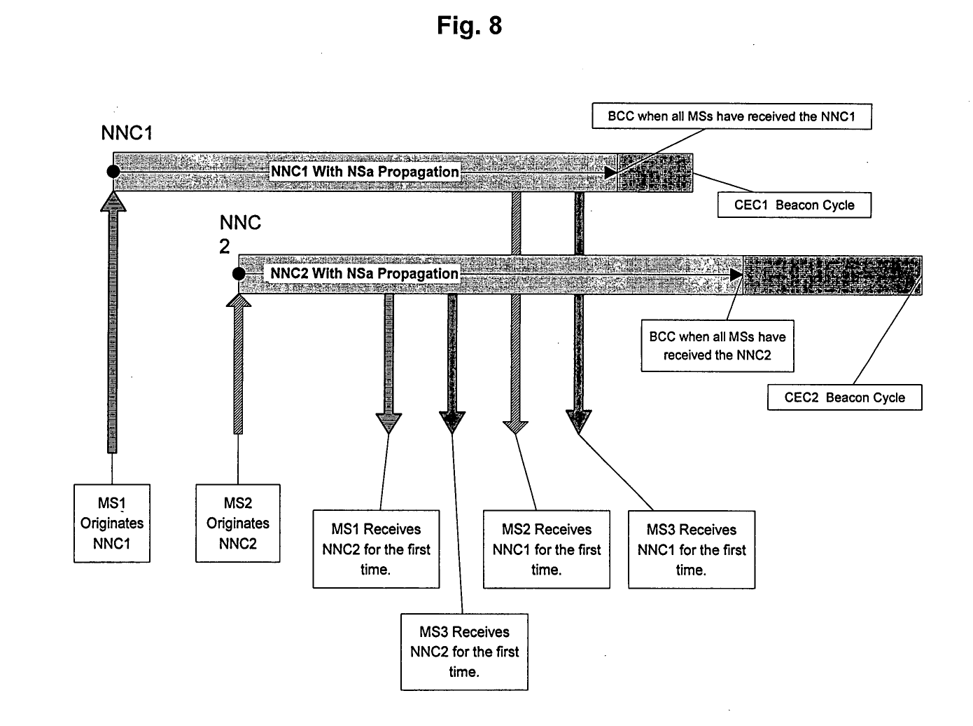

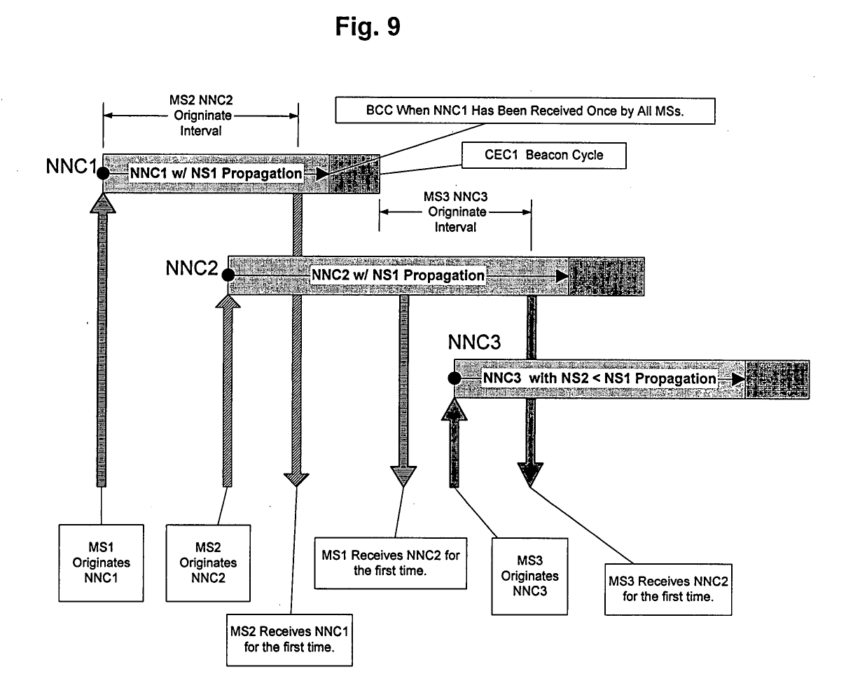

The NNC MCmd contains three fields that are needed to process overlapping NNC MCmds: the Originator NS field, the Originator SID field, and the LBL field. These are required because of possibilities shown by FIG. 8 and FIG. 9, which are time lines of the events associated with two NNC commands and three NNC commands, respectively. A separate bar shows the propagation of each MCmd. FIG. 8 shows that after MS1 has transmitted the NNC MCmd, but before MS2 has received it, MS2 may send its own NNC MCmd after losing a beacon. The Originator SID field is the unique identifier for the NNC MCmd because only one NNC command can be associated with an MS at a time. Therefore, each MS shall retransmit every NNC command that it receives with a distinct Originator SID field, unless their LBL fields are identical. Note that, because the originator can be any MS in the mesh, it is possible for a particular MS (e.g., MS3 in FIG. 8) to receive the NNC MCmds in a different order than they were transmitted.

FIG. 9 is used to show why the NS field and the DMB temporary data are required. The “MS2 NNC2 Originate Interval” in FIG. 9 is the same interval in which NNC2 was generated in FIG. 8. The “MS3 NNC3 Originate Interval” is a different type of interval because NNC1 MCmd has completed on beacon cycle CEC1, and the remaining zeros in the BDBF field of NNC1 have caused a decrease in the value of NS from NS1 to NS2. Since NNC2 was transmitted before the CEC1 beacon cycle, the transmitted NS in NNC2 is larger than the newer NS being sent in all of the post-CEC1 beacons.

The following is an explanation of the “preprocessing” required in Step 55 in FIG. 7. When MS1, MS2, or MS3 receive NNC2 after the CEC1 beacon cycle as in FIG. 9, then they shall first perform the following operations if and only if the Origination NS in the NNC is same as the current NS:
1. NNC commands from different originators are considered redundant if the LBLs are identical. Only one NNC command shall be retransmitted. The NNC MCmd with the smallest CEC shall be retransmitted if the CECs are different, otherwise the NNC with the smallest originator SID shall be retransmitted.

If the originator NS is greater than the current (beacon) NS, then perform the following preprocessing operation per MS:
1. If any SID in the LBL field is the same as an SID represented by a zero in the DMB, then that LBL entry shall be eliminated from the NNC MCmd before retransmission. The eliminated LBL entry represents an MS that has already been dropped from the mesh network. If all of the entries in the LBL represent member stations that have already been dropped from the mesh network, then the received NNC MCmd shall be ignored and not retransmitted.
2. The received BDBF shall be reduced according to the DMB retained from the completion of the previous NNC MCmd.
3. The remaining entries in the LBL shall be decremented by the number of ‘0’s in the DMB that represent SIDs that are smaller than the LBL entry. This is the same rule used to modify the SID values of the remaining MSs after one or more MS has been dropped.
4. Compress the received BDBF by eliminating the same bit positions of the BDBF as the zeros in the DMB. The result of this operation is that the retransmitted BDBF no longer contains any of the dropped MSs.
5. Set the Originator NS to the current (beacon) NS.
6. Eliminate NNC commands from different originators that are redundant if LBLs are identical. The NNC MCmd with the smallest CEC shall be retransmitted if the CECs are different, otherwise the NNC with the smallest originator ID shall be retransmitted.
7. Finally, the NNC MCmd shall be retransmitted with the new values for BDBF, Originator NS, and LBL.

In FIG. 9, MS1, MS2, and MS3 may all be required to perform this BDBF preprocessing operation upon receipt of NNC2. This preprocessing on BDBF and originator NS shall be completed before performing any of the operations mentioned in Step 56.

Examples of One Lost Beacon

Suppose a linear network where each MS, except for the first and last MS, is only connected to two other MSs, as shown in FIG. 5a. (Note: The linear configuration is the worst possible in terms of number of links between piconets. All ΔT values are calculated assuming a linear configuration.) If MS_{c} were to leave the network as in FIG. 5b, then both MS_{b} and MS_{d} would detect this. MS_{b} and MS_{d} would each set the BDBFs to their NNBs and originate an NNC MCmd. Each sets the CEC to the current BCC+NS−N_{NNB}−RP. In this case NS=5 (MS_{c} is still treated as a member of the original mesh network, and N_{NNB}=1, since both MS_{b} and MS_{d} are currently only connected to one other MS. After a maximum (5-1-0), or 4, beacon cycles, MS_{c} will be dropped from the mesh network.

In this case, the original mesh network will split into two new mesh networks as a by-product of the invention's process. MSₐ and MS_{b} are still connected to each other but they cannot hear the beacons of MS_{d} and MSₑ, as in FIG. 5b. The same is true for MS_{d} and MSₑ—they cannot hear MSₐ and MS_{b}. Therefore, when MS_{c} is dropped from the entire network, MSₐ and MS_{b} form a network, and MS_{d} and MSₑ form another network. This all happens by the end of 4 beacon cycle counts after MS_{c} leaves the network. MS_{d} then becomes the root MS of its mesh network when its SID is decremented by 3 as a result of the 3 zeros in its final BDBF=11000, and MSₐ retains the title of root MS for its mesh network with its final BDBF=00011. MS_{d} will then be in charge of updating the BCC for the mesh network containing MS_{d} and MSₑ.

FIG. 6a through FIG. 6c show a more complex (non-linear) network configuration. This example is used to show how the lost beacon is resolved and the mesh network is reorganized after a change is detected. Table 11 will help to show how the bitmaps are filled during each beacon cycle. In this example, MS₃ (SID=3) is dropped from the network. The lost beacon resolution process can be followed by stepping down through the rows of Table 11, with help from Table 12, which shows the NNBs and the N_{NNB} for each MS before and after MS₃ stops sending beacons. In both of these tables, as with previous examples, the lsb of all bitmaps is on the right hand side. The ‘1’s in the NNB corresponds to the lines connecting MSs in FIG. 6a and then FIG. 6b.

In Table 11, the “UNJOIN” at BCC=1 indicates that MS₃ beacon is no longer detected. When BCC=2, bit 3 in the NNB of both MS₄ and MS₂ changes from a ‘1’ to a ‘0’. The mesh network now has the topology shown in a FIG. 6b.

TABLE 11
One Lost Beacon Resolution Sequence

| BCC | Row Labels | MS₁ | MS₂ | MS₃ | MS₄ | MS₅ | MS₆ | MS₇ | MS₈ | LBL |
|---|---|---|---|---|---|---|---|---|---|---|
| | Bitmap Bit | 00000001 | 00000010 | 00000100 | 00001000 | 00010000 | 00100000 | 01000000 | 10000000 | |
| 0 | NNB | 00000010 | 01000101 | 00001010 | 10010100 | 01101000 | 00010000 | 00010010 | 00001000 | |
| 1 | NNB | 00000010 | 01000101 | UNJOIN | 10010100 | 01101000 | 00010000 | 00010010 | 00001000 | |
| 2 | NNB | 00000010 | 01000001 | **** | 10010000 | 01101000 | 00010000 | 00010010 | 00001000 | |
| 3 | NNB | 00000010 | 01000001 | **** | 10010000 | 01101000 | 00010000 | 00010010 | 00001000 | |
| | RLB1-BDBF | — | 01000001 | **** | — | — | — | 01010011 | — | 3 |
| | RLB1-CEC | — | 8 | **** | — | — | — | 8 | — | |
| | RLB2-BDBF | — | — | **** | 10010000 | 11111000 | 11111000 | — | 10011000 | 3 |
| | RLB2-CEC | — | — | **** | 9 | 9 | 9 | — | 9 | |
| 4 | NNB | 00000010 | 01000001 | **** | 10010000 | 01101000 | 00010000 | 00010010 | 00001000 | |
| | RLB1-BDBF | 01000011 | 01010011 | **** | — | 01111011 | 01111011 | 01111011 | — | 3 |
| | RLB1-CEC | 8 | 8 | **** | — | 8 | 8 | 8 | — | |
| | RLB2-BDBF | — | — | **** | 11111000 | [symbol] | [symbol] | — | 11111000 | 3 |
| | RLB2-CEC | — | — | **** | 9 | [symbol] | [symbol] | — | 9 | |
| 5 | NNB | 00000010 | 01000001 | **** | 10010000 | 01101000 | 00010000 | 00010010 | 00001000 | |
| | RLB1-BDBF | 01010011 | 01111011 | **** | 11111011 | 11111011 | 11111011 | 11111011 | 11111011 | 3 |
| | RLB1-CEC | 8 | 8 | **** | 8 | 8 | 8 | 8 | 8 | |
| | RLB2-BDBF | — | — | **** | [symbol] | — | — | — | [symbol] | 3 |
| | RLB2-CEC | — | — | **** | [symbol] | — | — | — | [symbol] | — |
| 6 | NNB | 00000010 | 01000001 | **** | 10010000 | 01101000 | 00010000 | 00010010 | 00001000 | |
| | RLB1-BDBF | 01111011 | 11111011 | **** | 11111011 | 11111011 | 11111011 | 11111011 | 11111011 | 3 |
| | RLB1-CEC | 8 | 8 | **** | 8 | 8 | 8 | 8 | 8 | |
| 7 | NNB | 00000010 | 01000001 | **** | 10010000 | 01101000 | 00010000 | 00010010 | 00001000 | |
| | RLB1-BDBF | 111111011 | 11111011 | **** | 11111011 | 11111011 | 11111011 | 11111011 | 11111011 | 3 |
| | RLB1-CEC | 8 | 8 | **** | 8 | 8 | 8 | 8 | 8 | |
| 8 | Bitmap Bit | 0000001 | 0000010 | | 0000100 | 0001000 | 0010000 | 0100000 | 1000000 | |
| | NNB | 0000010 | 0100001 | | 1001000 | 0110100 | 0001000 | 0001010 | 0000100 | |
| | DMB | 11111011 | 11111011 | | 11111011 | 11111011 | 11111011 | 11111011 | 11111011 | |

TABLE 12
NNB and N_{NNB} Before and After Losing the MS₃ Beacon.
(See FIG. 6a and FIG. 6b for mesh network topology)

| | |
|---|---|
| BCC = 1 | BCC > 1 |

| SID | NNB | N_{NNB} | NNB | N_{NNB} |
|---|---|---|---|---|
| 1 | 00000010 | 1 | 00000010 | 1 |
| 2 | 01000101 | 3 | 01000001 | 2 |
| 3 | 00001010 | 2 | — | — |
| 4 | 10010100 | 3 | 10010000 | 2 |
| 5 | 01101000 | 3 | 01101000 | 3 |
| 6 | 00010000 | 1 | 00010000 | 1 |
| 7 | 00010010 | 2 | 00010010 | 2 |
| 8 | 00001000 | 1 | 00001000 | 1 |

When BCC=3, MS₂ signals the change in its NNB by originating the NNC1 MCmd with CEC1=BCC+NS−N_{NNB}−RP=3+8−2−1=8, where N_{NNB} is the number ‘1’s in NNB, and RP is ‘1’ since the SID of the lost beacon (3) is greater than the SID of the detecting MS, (2). Similarly, MS4 originates the NNC2 MCmd with CEC=BCC+NS−N_{NNB}−RP=3+8−2−0=9, where RP is 0 because the SID of the lost beacon (3) is less than the SID of the detecting MS, (4). The two commands have identical LBLs, reporting that the beacon of MS₃ has been lost.

In Table 11 for BCC=3, the BDBF entries are the BDBFs transmitted by the indicated MS. These are calculated by ORing all of the BDBFs received since the MS transmitted its beacon in the previous beacon cycle (2), and with its own NNB. We define the BDBF for NNCₓ MCmd as BDBFₓ. Thus for MS₄, BDBF₄=NNB₄, for MS₅, BDBF₅=NNB₄ [symbol] NNB₅, MS₆, BDBF₆=NNB₄ [symbol] NNB₅ [symbol] NNB₆, and for MS₇, DBF₇=NNB₂ [symbol] NNB₇.

While BCC=4, the NNC1 MCmd is retransmitted by MS₁ with BDBF₁ calculated using the BDBF₂ transmitted by MS2 in the previous beacon cycle ORed with the NNB from MS₁. MS₄ calculates a new BDBF₄ by ORing the previous BDBFs for MS₅ and MS₈ with its own previous BDBF₄. In this case there was no BDBF for MS₈ in the previous beacon cycle. MS₅ calculates its BDBF₅ from the current value of BDBF₁, the newly calculated value for BDBF₄ for MS₄, and the previous BDBF values for MS₅, MS₆ and MS₇.

In general, for any MSₖ, the value for BDBFₖ is calculated (with the connectivity in FIG. 6b) using the connected neighbor's previous BDBF when the connected neighbor has an SID greater than the SID of MSₖ. Otherwise, if the neighbor SID, SIDⱼ, is smaller than that of SIDₖ, the newly calculated value of BDBFⱼ is used in the calculation for BDBFₖ. Therefore, it is best to calculate the values for BDBFₖ in Table 11 from the smallest SID to the largest SID.

For BCC=4, the X'ed out NNC2 entries for MS5 and MS6 indicate that NNC2 MCmd is assessed as redundant because the LBL is identical to that of NNC1 and CEC2>CEC1. NNC2 is therefore not retransmitted, and is subsequently ignored by MS₅ and MS₆.

The propagation of NNC1 and NNC2 continue during BCC=5, with MS₄ and MS₈ also eliminating NNC2 as redundant. NNC2 is not shown in subsequent beacon cycles.

In BCC=6, MS₁ is the only remaining member that does not have the final BDBF1=11111011. At BCC=7, all members have the final value of BDBF1.

When BCC=CEC1=8, a copy of the BDBF is retained as DMB and saved for NS beacon cycles. All members drop the MS₃ bit from all bitmaps, including NNB, because bit 3 in the BDBF is a ‘0’ indicating that no MS can receive a beacon from MS₃. Each MS, whose SID is greater than 3, decrements the SID by ‘1’. The renamed MSs are now consistent with the modified bitmaps.

Example of Two Lost Beacons

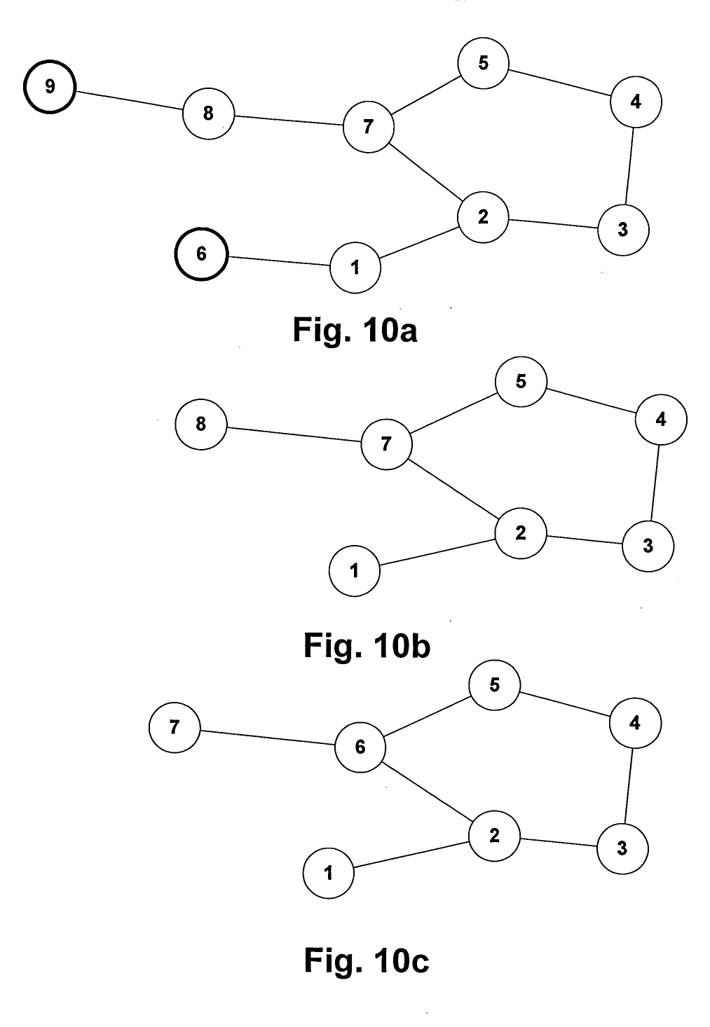

The two-MS drop case is based on the network shown in FIG. 10a. Table 13 shows the sequence of NNC commands for resolving the lost beacon of MS₉, which happens during BCC=2, followed by the lost beacon of MS₆ during BCC=4. The word “UNJOIN” indicates the loss of a beacon for that MS is detected.

The first change that the loss of MS₉ produces is that the msb of the NNB for MS₈ is no longer set in BCC=2. This corresponds to the deletion of MS₈ between FIG. 10a and FIG. 10b.

Next, MS₈ sends the NNC1 MCmd in response to the loss of MS₉ during BCC=3. The CEC1 is calculated as BCC+NS−N_{NNB}−RP=3+9−1−1=10. N_{NNB} is ‘1’ because there is only one beacon left in the NNB of MS₈. This corresponds to the line connecting MS8 and MS7 shown in FIG. 10b. RP is 1 because the SID of the loss beacon (9) is larger than the SID of the originator of the NNC1 (8). The LBL is the SID of the lost beacon as shown in the last column of the Table 13.

The beacon of MS₆ is lost during BCC=4, which produces a change in the NNB of MS₁. When BCC=5, MS₁ originates NNC2 to resolve the loss of MS₆. CEC2=BCC+NS−N_{NNB}−RP=5+9−1−1−=12. The mesh now looks like FIG. 10b. The NNC2 MCmd propagates among all of the MSs during BCC=5, because the sequence of beacons is in SID order, 1, 2, 3 . . . 9. Each MS can receive every proceeding beacon before transmitting its own. The BDBF is formed when each MS performs a logical OR operation on all received versions of BDBFs since it transmitted its previous beacon. In this case, the BDBF contains ‘0’s for both lost beacons by the time it propagates to MS₈.

TABLE 13
Two Lost Beacons Resolution Sequence

| BCC | Row Labels | MS₁ | MS₂ | MS₃ | MS₄ | MS₅ |
|---|---|---|---|---|---|---|
| | Bitmap Bit | 000000001 | 000000010 | 000000100 | 000001000 | 000010000 |
| 1 | NNB | 000100010 | 001000101 | 000001010 | 000010100 | 001001000 |
| 2 | NNB | 000100010 | 001000101 | 000001010 | 000010100 | 001001000 |
| 3 | NNB | 000100010 | 001000101 | 000001010 | 000010100 | 001001000 |
| | NNC1-BDBF | — | — | — | — | — |
| | NNC1-CEC | — | — | — | — | — |
| 4 | NNB | 000000010 | 001000101 | 000001010 | 000010100 | 001001000 |
| | NNC1-BDBF | — | — | — | — | — |
| | NNC1-CEC | — | — | — | — | — |
| 5 | NNB | 000000010 | 001000101 | 000001010 | 000010100 | 001001000 |
| | NNC1-BDBF | — | 011010111 | 011011111 | 011011111 | 011011111 |
| | NNC1-CEC | — | 10 | 10 | 10 | 10 |
| | NNC2-BDBF | 000000010 | 001000111 | 001001111 | 001011111 | 001011111 |
| | NNC2-CEC | 12 | 12 | 12 | 12 | 12 |
| 6 | NNB | 000000010 | 001000101 | 000001010 | 000010100 | 001001000 |
| | NNC1-BDBF | 011010111 | 011011111 | 011011111 | 011011111 | 011011111 |
| | NNC1-CEC | 10 | 10 | 10 | 10 | 10 |
| | NNC2-BDBF | 001000111 | 011011111 | 011011111 | 011011111 | 011011111 |
| | NNC2-CEC | 12 | 12 | 12 | 12 | 12 |
| 7 | NNB | 000000010 | 001000101 | 000001010 | 000010100 | 001001000 |
| | NNC1-BDBF | 011011111 | 011011111 | 011011111 | 011011111 | 011011111 |
| | NNC1-CEC | 10 | 10 | 10 | 10 | 10 |
| | NNC2-BDBF | 011011111 | 011011111 | 011011111 | 011011111 | 011011111 |
| | NNC2-CEC | 12 | 12 | 12 | 12 | 12 |
| 8 | NNB | 000000010 | 001000101 | 000001010 | 000010100 | 001001000 |
| | NNC1-BDBF | 011011111 | 011011111 | 011011111 | 011011111 | 011011111 |
| | NNC1-CEC | 10 | 10 | 10 | 10 | 10 |
| | NNC2-BDBF | 011011111 | 011011111 | 011011111 | 011011111 | 011011111 |
| | NNC2-CEC | 12 | 12 | 12 | 12 | 12 |
| 9 | NNB | 000000010 | 001000101 | 000001010 | 000010100 | 001001000 |
| | NNC1-BDBF | 011011111 | 011011111 | 011011111 | 011011111 | 011011111 |
| | NNC1-CEC | 10 | 10 | 10 | 10 | 10 |
| | NNC2-BCBF | 011011111 | 011011111 | 011011111 | 011011111 | 011011111 |
| | NNC2-CEC | 12 | 12 | 12 | 12 | 12 |
| 10 | Bitmap Bit | 0000001 | 0000010 | 0000100 | 0001000 | 0010000 |
| | NNB | 0000010 | 0100101 | 0001010 | 0010100 | 0101000 |
| | DMB | 011011111 | 011011111 | 011011111 | 011011111 | 011011111 |
| | NNC2-BDBF | 1111111 | 1111111 | 1111111 | 1111111 | 1111111 |
| | NNC2-CEC | 12 | 12 | 12 | 12 | 12 |
| 11 | Bitmap Bit | 000001 | 0000010 | 0000100 | 0001000 | 0010000 |
| | NNB | 0000010 | 0100101 | 0001010 | 0010100 | 0101000 |
| | DMB | 011011111 | 011011111 | 011011111 | 011011111 | 011011111 |

| BCC | Row Labels | MS₆ | MS₇ | MS₈ | MS₉ | LBL |
|---|---|---|---|---|---|---|
| | Bitmap Bit | 000100000 | 00100000 | 010000000 | 100000000 | |
| 1 | NNB | 000000001 | 010010010 | 101000000 | 010000000 | |
| 2 | NNB | 000000001 | 010010010 | 001000000 | UNJOIN | |
| 3 | NNB | 000000001 | 010010010 | 001000000 | **** | 9 |
| | NNC1-BDBF | — | — | 001000000 | **** | |
| | NNC1-CEC | — | — | 10 | **** | |
| 4 | NNB | UNJOIN | 010010010 | 001000000 | **** | |
| | NNC1-BDBF | **** | 011010010 | 011010010 | **** | 9 |
| | NNC1-CEC | **** | 10 | 10 | **** | |
| 5 | NNB | **** | 010010010 | 001000000 | **** | |
| | NNC1-BDBF | **** | 011011111 | 011011111 | **** | 9 |
| | NNC1-CEC | **** | 10 | 10 | **** | |
| | NNC2-BDBF | | 011011111 | 011011111 | **** | 6 |
| | NNC2-CEC | **** | 12 | 12 | **** | |
| 6 | NNB | | 010010010 | 001000000 | **** | |
| | NNC1-BDBF | **** | 011011111 | 011011111 | **** | 9 |
| | NNC1-CEC | **** | 10 | 10 | **** | |
| | NNC2-BDBF | | 011011111 | 011011111 | **** | |
| | NNC2-CEC | **** | 12 | 12 | **** | |
| 7 | NNB | **** | 010010010 | 001000000 | **** | |
| | NNC1-BDBF | **** | 011011111 | 011011111 | **** | 9 |
| | NNC1-CEC | **** | 10 | 10 | **** | |
| | NNC2-BDBF | **** | 011011111 | 011011111 | **** | 6 |
| | NNC2-CEC | **** | 12 | 12 | **** | |
| 8 | NNB | **** | 010010010 | 001000000 | **** | |
| | NNC1-BDBF | **** | 011011111 | 011011111 | **** | 9 |
| | NNC1-CEC | **** | 10 | 10 | **** | |
| | NNC2-BDBF | **** | 011011111 | 011011111 | **** | |
| | NNC2-CEC | **** | 12 | 12 | **** | |
| 9 | NNB | **** | 010010010 | 001000000 | **** | |
| | NNC1-BDBF | **** | 011011111 | 011011111 | **** | 9 |
| | NNC1-CEC | **** | 10 | 10 | **** | |
| | NNC2-BCBF | **** | 011011111 | 011011111 | **** | 6 |
| | NNC2-CEC | **** | 12 | 12 | **** | |
| 10 | Bitmap Bit | **** | 0100000 | 1000000 | **** | |
| | NNB | **** | 1010010 | 0100000 | **** | |
| | DMB | **** | 011011111 | 011011111 | **** | |
| | NNC2-BDBF | **** | 1111111 | 1111111 | **** | **** |
| | NNC2-CEC | **** | 12 | 12 | **** | |
| 11 | Bitmap Bit | **** | 0100000 | 1000000 | **** | |
| | NNB | **** | 1010010 | 0100000 | **** | |
| | DMB | **** | 011011111 | 011011111 | **** | |

Since MS₇ and MS₂ are within range of each other. NNC1 propagates from MS₂ starting on BCC=5 as a result of the NNC1 sent in the beacon of MS₇ during BCC=4.

For BCC=6 to BCC=9, both NNC MCmds are propagated through the mesh network. When BCC=9, NNC 1 propagation has resolved dropped beacons, 6 and 9. The reason that both lost beacons are resolved in NNC1 is that MS₆ was not connected to an MS that NNC1 had reached before its beacon was lost. If MS₆ had been within range of MS₈, the bit corresponding to MS₆ would have remained set in the NNB of MS₈. This is because MS₈ takes a snapshot of its NNB when originating the NNC1, which it uses to OR with subsequently received BDBFs until CEC1 time. For this case, only NNC2 would have detected the loss of MS₆ by all members of the mesh.

For the Table 13 case, when CEC=10 the DMB (=BDBF1, when BCC=9) contains a zero at the same SID position as the LBL of NNC2. This allows each MS to eliminate NNC2 as indicated in the text for FIG. 7, Step 55.

Since the BDBF contains ‘0’s at the SID=6 and SID=9 bits, those positions in the NNB bitmap are eliminated. In addition, NS becomes 9−2=7. In order for the remaining MSs to correspond the to the correct bits in the new NNBs, MS₈ and MS₇ must decrement their SIDs by 1. In FIG. 7, this was shown as Step 60. There is one ‘0’ in the BDBF at SID=6, which is less than 8 and less than 7. The final mesh network at BCC=10 is shown in FIG. 10c.

Sharing Member Frame Intervals

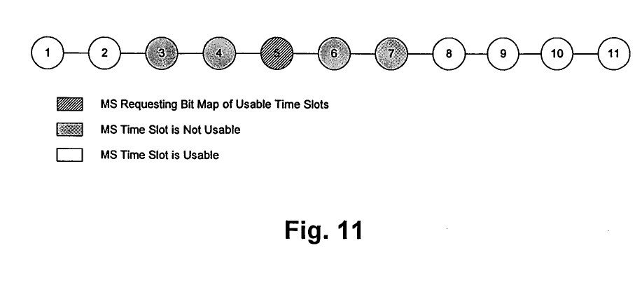

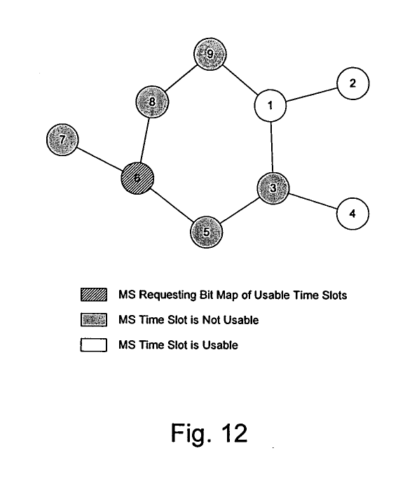

Regardless of the topology of the mesh network, each MS can fundamentally only transmit during its MF interval (time slot) (FIG. 1 and FIG. 2). If an MS is only within range of a few other members, then there is the possibility that the MS can transmit at the same time as some other member without interfering with any other MF transmission. FIG. 11 and FIG. 12 show that the MS represented as a circle with lines can transmit during the same time slot as an MS represented by a white circle, but may not transmit at the same time as an MS represented as the shaded circle. Described here is the method that allows sharable time slots determination, acquisition for use, and finally releasing the time slots when done.

Determining Sharable Member Frame Time Slots

In order to determine what time slots can be shared, the connectivity of the network must be determined one level deeper than the NNB of the node requesting the bandwidth. This is due to the following. A node (say MSₓ) must not be within range of both the requesting node and the node whose timeslot it is requesting. Otherwise, MSₓ will hear two devices transmitting at once. What the requestor MS needs is a bitmap of all MS IDs that are not usable because the MSs can hear both the requestor and the MS whose time slot is being requested.

FIG. 11 indicates this for a linear mesh with 11 MSs. The MS with the SID=5, MS₅, wants to use the same time slot as another member. The shaded MSs are those whose time slots cannot be used. For example MS₃ cannot be used because MS₄ can hear both MS₅ and MS₃. A Non-Usable Slot Bitmap (NUSB) is defined such that NUSB=00001111100, where all the 1's are in the bit positions representing MSs that whose time slots cannot be uses by MS₅, (the SID=1 position is the right-most bit). Thus the ‘0’s in the NUSB represent the MSs with sharable MF intervals.

The NUSB is determined using the Map Available Slots (MAS) MCmd defined in Table 14.

TABLE 14
MAS MCmd Format
Map Available Slots (MAS) MCmd

| Parameter | Data Type | Value or Note |
|---|---|---|
| MCmd Code | U8 | MAS code |
| Length of MCmd | U8 | 1 + Size of NUSB + Size of BCC |
| Originator SID | U8 | SIDy of the MAS originator |
| CEC | Size of BCC | BCC + NS − N_{NNB} |
| NUSB | ┌NS/8┐ | Bitmap of usable and not usable MF |
| | Bytes | intervals. |

The MAS MCmd is executed, and the NUSB is computed as follows:
1. The requesting MSₓ originates MAS command with a NUSB set to the originator NNB with the addition that the MSx bit is also set. CEC=BCC+NS−N_{NNB}.
2. For any MS receiving the command: If the SID of the originator is in its NNB then replace the value received for the NUSB with the received NUSB ORed with its own NNB.
3. Retransmit the MAS command with the modified NUSB field.
4. Do this until BCC=CEC.
5. The value of NUSB that comes back to the originator at BCC=CEC has 0's in bit positions representing MFs that may be requested.

This algorithm works for both linear and non-linear topology cases. FIG. 12 is the diagram for a nonlinear topology with 9 MSs. To arrive at the value for the NUSB when the MS₆ is the requester, the value the NNBs of MS₆, MS₅, MS₇ and MS₈ are ORed together. Remembering that the SID=1 bit is at the right hand end of the string, the NNBs are as follows: NNB₆=011010000, NNB₅=000100100, NNB₇=000100000, NNB₈=100100000. The resulting non-usable slot bitmap NUSB6 will be 111110100, so time slots from MS₁, MS₂, and MS₄ are ones that can be acquired for reuse by MS₆.

If MS₉ is the requester then NUSB₉=110100111. The usable time slots are those of MS₄, MS5, and MS₇.

Acquiring Sharable Member Frame Time Slots

Now that possible MFs are known from the MAS command, it is now desirable to actually acquire one or more of them for use. Any MS using an acquired time slot shall keep track of which time slots that it has acquired and its NUSB. The shared slots are recorded using a Shared Slot Bitmap (SSB). For an MS requesting one or more time slots, it shall transmit an Acquire Time Slots (ATS) MCmd, with a Granted Slot Bitmap, GSB, initialized to the one's compliment of NUSB indicating that all possible time slots are granted. An MS shall only originate an ATS MCmd if there is no pending ATS MCmd being received.

A receiving MS, MSₓ, may alter the GSB by resetting one or more of the bits before retransmitting the GSB in its own beacon.

TABLE 15
ATS MCmd Format
Acquire Time Slots (ATS) MCmd

| Parameter | Data Type | Value or Note |
|---|---|---|
| MCmd Code | U8 | ATS code |
| Length of MCmd | U8 | 1 + Size of NUSB + Size of BCC |
| Originator SID | U8 | SIDy of the ATS originator |
| CEC | Size of BCC | BCC + NS − N_{NNB} |
| GSB | ┌NS/8┐ Bytes | Bitmap of granted MF intervals. |

The algorithm for resetting the bits is based on the fact that two MSs may not use the same time slot if any MS can receive both of their beacons. The algorithm is as follows. In other words, a neighbor's neighbor shall not allow a shared slot that the neighbor's neighbor is already using (sharing) because the two transmissions will collide on their common neighbor. If there is a ‘1’ in the receiver NUSB, NUSBₓ, at the bit position corresponding to the originator SID, then there will be a collision if MSx and the originator both use the same time slot. Therefore, the receiving MSₓ resets the proper bits in the received GSB with the following operation: GSB=(GSB [symbol] SSBx)⊕GSB, where ⊕ is the exclusive-OR operation. The new value is used in the retransmitted ATS MCmd. If the receiving MS is not using any shared time slots, then SSBₓ is all zeros, and the MSₓ retransmits the ATS MCmd without altering GSB.

When BCC=CEC, the originator has a copy of GSB that contains ‘1’s in the bit positions for sharable time slots that it is allowed to use. The originator may now send data during those shared timeslots without the possibility of interfering with other MSs.

When an MS stops using a previously acquired slot, it shall send a Release Time Slot (RTS) MCmd containing a list of the time slots that are no longer being used. The RTS MCmd is shown in Table 16. This command informs the network that the time slot is available for use by any MS, and in particular, an MS whose request was previously rejected. The receipt of this command by the original requestor will result in it sending a new request (ATS) for that time slot.

TABLE 16
RTS MCmd Format
Release Time Slots (RTS)

| Parameter | Data Type | Value or Note |
|---|---|---|
| MCmd Code | U8 | Value for RTS |
| Length of MCmd | U8 | Size of CEC + Size of NS + |
| | | (n + 1) * (Size of SID) |
| CEC | Size of BCC | Range of BCC |
| Originator SID | Size of SID | SID of the RTS originator. |
| Released Slot List | Size of NS | The value, n, is always |
| (RSL) Length | | greater than or equal to 1 |
| | | and less than NS |
| Released Time Slot SID1 | Size of SID | First released time slot SID. |
| . | . | . |
| . | . | . |
| . | . | . |
| Released Time Slot SIDn | Size of SID | Last released time slot SID. |

Roaming Within a Mesh Network

If an MS is free to move about the area of the mesh network, these movements can change the network topology and cause a given MS to be in or out of range with the roaming MS. Therefore, every time an MS moves, the NUSB and the GSB may need to be re-determined since there is the possibility of a shared slot time causing interference.

There are two possible situations for movement within the network. One is an MS moving out of range of one neighbor MS and into range of another. An MS originating the NNC MCmd indicates the absence of a beacon, which is then resolved as no ‘0’s in the final BDBF, and therefore no members dropped from the network.

The second case is a member that does not roam out of range of any other member and does move within range of at least one new member. The member that detects a previously unheard member (MS_{z}) beacon shall also originate an NNC MCmd with MS_{z} in the LBL parameter.

When any MS that is sharing a time slot receives an NNC MCmd, the MS shall cease using that shared slot. The MS shall then originate an MAS MCmd followed by an ATS MCmd to re-acquire usable shared time slots.

RF Interference and MCmd Propagation

RF Interference from sources not associated with the mesh network will increase the time required to propagate an MCmd throughout the mesh network. The only MCmd that can detect if it has not fully propagated at CEC time is NNC. The parameter BDBF will only have a ‘0’ in a location that is not included in the LBL parameter if NNC has not fully propagated through the mesh. Any MS satisfying this condition interprets the result as “no change to the mesh.” This was shown in Step 58 of FIG. 7, and must continue to propagate NNC for an additional period of time, which will be implementation dependent.

In order for other commands to share this capability, the parameter shown in Table 17 must be added each MCmd except NNC. This shall be the last parameter in the MCmd if it is present.

TABLE 17
MPB Parameter Format
MCmd Propagation Bitmap (MPB) Parameter

| Parameter | Data Type | Value or Note |
|---|---|---|
| MPB | ┌NS/8┐ Bytes | Bitmap of MSs Retransmitting an MCmd. |

When an MS receives an MCmd containing the MPB parameter, it shall set the bit corresponding to its own SID and retransmit the MCmd. The CEC of each MCmd must be initially set to CEC=BCC+NS−N_{NNB} by the originator, in order to allow both for the original MCmd and the retransmitted command to propagate. At CEC time, each MS checks to see if there are any ‘0’s remaining in the MPB. Any zero corresponds to an MS that either did not receive the MCmd at all, or did not receive in time to propagate the modified MPB to the rest of the mesh.

There are several possible methods for recovering a zero in the MPB. The individual station may do nothing and wait for the result to be propagated by a node with which the MCmd did complete successfully, or it may continue to propagate the MCmd for an additional interval, new CEC parameter. In addition, originator of the original MCmd may re-originate the MCmd that did complete successfully. The exact recovery mechanism is implementation dependent. Depending on the mechanism chosen, an additional propagation time parameter may have to be added to the MCmd if this time parameter is needed to calculate the extended CEC time.

Advantages Of This Mesh Network Implementation

Data structures (bitmaps) for control scale linearly with the number of mesh network members, NS.
Complexity of resolving a lost beacon is efficient and independent of the number of members in the mesh.
Multiple lost beacons are resolved correctly regardless of when the lost beacons occur and at the earliest possible times
Time slots can be shared as much as the network topology allows.
Roaming of members and partitioning of mesh into independent parts is supported transparently.
Joins can be done either with one unjoined station, or an entire unjoined mesh network.

1. A method for managing a wireless network of member stations, comprising the steps of:
joining a station to a mesh network of stations;
adding together two networks of member stations;
removing a member station from the network;
moving a member station within a network; and
sharing time slots used by other members.

2. The method of claim 1 wherein the step of joining a station to a mesh network further comprises the steps of:
a) operating the unjoined station on the same frequency as the mesh network;
b) if the unjoined station is in a range of a mesh member station, detecting and decoding a beacon transmitted by a mesh member station;
c) the unjoined station transmitting a request-to-join command to the mesh member during its time slot;
d) one mesh member station authenticating the requested unjoined station;
e) the authenticating mesh member station granting permission for the unjoined station to join the mesh network at a specified join time, and propagating that information throughout the joining mesh network;
f) the unjoined station becoming a member of the mesh network at the specified join time, and updating network topology with the new member in the network.

3. The method of claim 1 wherein the step of adding together two networks of member stations further comprises the steps of:
a) a first detecting member station in a first network detecting a second detecting member station in a second network; b) the second detecting member station detecting the first detecting member station; c) the first and second detecting member stations exchanging overall network size parameters for comparison;
d) the detecting member station in the smaller network sending to the detecting member station in the larger network a request to join the larger network, which is acknowledged by the larger network;
e) the detecting member station in the larger network completing the authentication process and informing its other members that the smaller network will be joining the larger network at a specific future time;
f) the detecting member station in the smaller network also receiving the larger network join message and the specific future time, propagating to the other members of the smaller network the command to stop transmitting;
g) at the specific future time, the member stations in both networks expanding all of their bitmaps to the length in bits of the combined network and the network size to the value equal to the size of the combined network;
h) at the specific future time, detecting member station in the larger network propagating to its own members and the detecting member station of the smaller network that the merge is beginning and will end at the second future time;
i) at the specific future time, the member stations of the smaller network calculating new ID numbers by adding their current ID number to the size of the larger network;
j) at the specific future time, the detecting member station in the smaller network adopting the larger network's cycle count and its current indicator of a change to the mesh membership or topology;
k) at the specific future time, the detecting member station in the larger network propagating a command to both the larger network members and the detecting member of the smaller network to begin the merge with the time of completion set to a second future time.
l) all members of the larger network and the detecting member of the smaller network beginning to propagate the combined total size to other member stations in the combined network;
m) each member of the smaller network restarting its transmissions in synchronization with the detecting member station in the smaller network using the size of the combined network, their updated ID numbers, and the expanded bitmaps of the combined network;
n) all member stations in the combined network propagating the combined network parameters in their transmissions;
o) at the second future time, the start of detecting a possible missing member station of the combined mesh to be removed from the expanded bitmaps of all remaining member stations at a third future time.

4. The method of claim 1 wherein the step of removing a member station from the network further comprises the steps of:
a) a first member station detecting that a neighboring member station is no longer present;
b) the first member station setting a timer to allow for propagation of the identification of the lost neighboring member station;
c) the first member station transmitting a loss of contact signal to notify the loss of the neighboring member station, an indication of current nearest neighbors, and the member(s) no longer present;
d) all member stations receiving the loss of contact signal, determining if the loss of contact signal is redundant and contains the same lost station ID as the one that has already been dropped from processing a previous loss of contact signal, and eliminating redundant loss of contact signals and excluding previously eliminated member stations;
e) each member station propagating the received loss of contact signal to its neighboring member stations, and signaling the identities of all the member stations it can hear pooled with the identities of all the member stations audible to the other member stations in the network as propagated by them;
f) for any listed member stations in the network not audible to any signaling member station, dropping all non-audible member stations from the network; and
all member stations adjusting their identities and remapping the network to eliminate any lost member stations and updating its current indicator of a change to the mesh membership or topology.

5. The method of claim 1 wherein the step of moving a member station within a network further comprises the steps of:
a) a member station detecting that a neighboring member station is no longer present, or a member station in the network detecting a previously unheard member, or both;
b) the detecting member station setting a propagation timer to allow for propagation of the identification of a change in nearest neighbor stations;
c) the detecting member station transmitting a loss of contact signal to notify the change in the neighboring member station, an indication of current nearest neighbors, and the member(s) no longer present, if any;
d) all member stations receiving the loss of contact signal, determining if the loss of contact signal is redundant and contains the same lost station ID as the one that has already been dropped from processing a previous loss of contact signal, and eliminating redundant loss of contact signals and excluding previously eliminated member stations;
e) each member station propagating the received loss of contact signal to its neighboring member stations, and signaling the identities of all the member stations it can hear pooled with the identities of all the member stations audible to the other member stations in the network as propagated by them;
f) when the propagation timer has timed out, for any listed member station in the network not audible to any signaling member station, dropping all non-audible member stations from the mesh network; and all member stations adjusting their identities and remapping the network to eliminate any lost member;
g) when the propagation timer has timed out, for all listed member stations still audible by at least one other member station, no dropping of any member station from the mesh network;
h) for either dropping or not dropping member stations from the mesh network, updating the current indicator of a change to the mesh membership or topology.

6. The method of claim 2 wherein the step of adding together two networks of member stations further comprises the steps of:
a) an unjoined station detecting member stations of two mutually non-communicating meshes; and
b) the unjoined station using the method of claim 2 to join either of the non-communicating mesh networks, the smaller network being preferred.

7. A method for a member station to make use of unused time slots in a member station beacon cycle, comprising the steps of:
a) having each member station keep a map of neighbor stations that the member station can hear, and the stations that neighbors can hear (neighbors-of-neighbors);
b) a first member station selecting one or more slots not listed in the map as slots that it requests to share;
c) the first member station transmitting a map of selected slots to the other member stations in the network to notify the member stations of its desire to use the slots;
d) each member station receiving the map of desired slots, removing a time slot from the map if interference would take place when the first member station uses the time slot, and propagating the resulting map to the remainder of the network;
e) after propagation of the map to all mesh members, the map containing the granted time slots that may be used by the first member station to transmit data;
f) The first member station using one or more granted time slots to transmit data;
g) the first member station marking the time slot as no longer in use as a map of released time slots, and transmitting the map to the other member stations in the network to notify them of the release.
h) the neighbor stations of the first member station receiving the map of released time slots, propagating the map to all other member stations, and so on throughout the mesh network.

8. The method claimed in claim 7, further comprising the steps of:
a) any member station using a shared time slot and receiving the loss of contact signal, stopping the use of all shared time slots;
b) the propagation timer for the loss of contact signal timing out with dropouts being resolved, and for all member stations for desiring to use shared time slots, re-determining what time slots can be shared.
c) creating a new neighbor and neighbor-of-neighbor map.
d) propagating a new requested slot map to obtain a new map of sharable time slots;
e) using the time slots specified by the map of sharable time slots to send data;
f) releasing aforementioned timeslots when they are no longer needed.

9. The method of claim 4 wherein the step of removing a member station from the network further comprises the steps of:
e) one of the member stations stopping transmission of its beacon;
f) one of the remaining member stations detecting the stopping of transmission and updating its NNB;
g) the remaining member station within range of the absent member, transmitting in its own beacon, a nearest neighbor change MCmd (NNC) and a change effect cycle count (CEC) value equal to current BCC+NS−N_{NNB}−RP, where NS is the total number of member stations before any member went off-line and N_{NNB} is the number of member stations whose beacons are now heard by the remaining member stations, and the parameter BDBF=NNB, and the LBL list of member stations whose beacons are newly lost;
h) each member station that has not already transmitted an NNC, but has received an NNC in the beacon from any other member station with an identical lost beacon list (LBL), retransmitting (thus repeating) an NNC and the smallest CEC received from any master station in its own next beacon;
i) every member station that has received a beacon with an NNC transmitting in its next beacon an NNC with a Beacon Detect Bitmap Flag (BDBF) having non-zero values in locations representing member stations that can be heard by that member station;
j) every member station receiving the BDBFs, logically OR-ing all of the BDBFs together with its own NNB, to produce an ORed BDBFs with NNB, and storing and retransmitting in its next beacon the NNC with ORed BDBFs with NNB as its BDBF parameter; and
k) every member station receiving the NNC with the ORed BDBF, logically OR-ing that BDBF with its stored BDBF to produce an updated BDBF, and storing and transmitting the updated BDBF in the retransmitted NNC; and repeating the steps of receiving, OR-ing, storing and transmitting until the cycle count BCC is equal to the value CEC;
l) the value of BCC=CEC being reached, and the BDBF containing one or more bits with the value zero, all member stations compressing all bitmaps to eliminate the positions represented by the ‘0’s in the BDBF, and reassigning the SIDs such that the remaining bit positions are assigned to the correct member stations;
m) if the value of BCC=CEC being reached and the BDBF containing only bits with the value ‘1’, making no changes to bitmaps or bitmap assignments.
n) each member station resuming beacon transmissions at the new beacon time specified by its modified SID.

10. The method of claim 1 wherein member stations compensate for delays in the propagation of time slot data, beacons, commands, and member station data by the steps of:
a) each member station transmitting a propagation bitmap with one bit for each member station corresponding to its station ID, and possibly transmitting an extended time parameter;
b) each station receiving the data with the propagation bitmap, setting the bit corresponding to its station ID, and propagating the data with the revised bitmap;
c) the original propagation time value being reached, each member station determining if there are any zeros remaining in the propagation bitmap;
d) a zero being present in the propagation bitmap, the station either taking no further action or terminating the operation;
e) or a zero being present in the propagation bitmap and the station continuing to propagate the command for an amount of time specified by the extended time parameter received with the propagation bitmap, and propagating a new extended time parameter;
f) a zero not being present in the propagation bitmap, the member station completing the required operation.

11. The method of claim 1 wherein any member station may be the controller of its own local area network (LAN) or personal area network (PAN).
